(19) United States
(12) Patent Application Publication
(10) Pub. No.: US 2006/0098027 A1
(43) Pub. Date: May 11, 2006

(54) Method and apparatus for providing call-related personal images responsive to supplied mood data

(76) Inventors: Myra Louise Rice, Durham, NC (US); Michael Shannon Welch, Raleigh, NC (US)

Correspondence Address: COATS & BENNETT/SONY ERICSSON, 1400 CRESCENT GREEN, SUITE 300, CARY, NC, 27511, US

(21) Appl. No.: 10/984,469

(22) Filed: Nov. 9, 2004

(51) Int. Cl. G09G 5/00

(52) U.S. Cl. 345/619

(57) ABSTRACT

The present invention describes a method and apparatus for providing an image in association with a call between two or more communication devices. In one exemplary embodiment of the present invention, a personal image of a user is either selected or modified responsive to supplied mood data. The resulting personal image is output to an output device in association with the call. In some embodiments, the personal image is output to a display in association with the call. In other embodiments, the personal image is output to a transceiver, which transmits the personal image to a remote communication device in association with the call.

### BACKGROUND

People typically use a wide variety of communication devices, such as mobile telephones, computers, etc., to communicate information. For example, an individual may communicate news to a friend, family member, or colleague using email, instant messages, voice calls, etc. While such communication tools enable the individual to quickly communicate the details of the news, conventional communication devices typically do not include mood information associated with the individual sending or responding to the news. This mood information is often critical for properly interpreting the news.

Limited forms of conventional communication tools, e.g., instant messaging services, enable users to include generic mood-based symbols, such as a smiley face, angry face, sad face, etc., with their message. However, while these mood-based symbols provide mood information, they require a user to actively select the graphical symbol that best corresponds to their mood. Further, because these mood-based symbols are generic, the appearance of the mood-based symbols is independent of the user selecting the mood.

### SUMMARY

The present invention describes a method for providing an image in association with a call between two or more communication devices. One exemplary method comprises selecting or modifying a personal image of a user responsive to supplied mood data, and outputting the personal image to an output device in association with the call. In some embodiments, the personal image is output to a display. In other embodiments, the personal image is output to a transceiver, which transmits the personal image to a remote communication device.

The present invention also describes a communication device for providing mood-based personal images in association with a call. According to one exemplary embodiment, a communication device comprises a processor and an output device. The processor is configured to select or modify a personal image responsive to mood data supplied to the communication device. The output device is configured to output the personal image in association with the call. In some embodiments, the output device comprises a display. In other embodiments, the output device comprises a transceiver.

### BRIEF DESCRIPTION OF THE DRAWINGS

FIG. 1 is a block diagram of one exemplary communication device according to the present invention.

FIG. 2 illustrates exemplary communication between two communication devices according to the present invention.

FIG. 3 is a block diagram of one exemplary mood input device according to the present invention.

FIG. 4 is a block diagram of one exemplary image processor according to the present invention.

FIG. 5 is a flow chart illustrating one exemplary method of the present invention.

FIG. 6 is a flow chart illustrating another exemplary method of the present invention.

FIG. 7 is a flow chart illustrating another exemplary method of the present invention.

### DETAILED DESCRIPTION

The present invention describes a communication device and a corresponding method for providing mood-based personal images in association with a call between two or more communication devices. As used herein, the term “communication device” may include a cellular wireless transceiver with or without a multi-line display; a Personal Communication System (PCS) terminal that may combine a wireless transceiver with data processing, facsimile, and data communication capabilities; a Personal Digital Assistant (PDA) that can include a wireless transceiver, pager, Internet/intranet access, web browser, organizer, calendar, and/or a global positioning system (GPS) receiver; a conventional laptop and/or palmtop receiver; a pager; or any other mobile device that includes a wireless transceiver to communicate information via a wireless interface. In addition, the term “communication device” may include a computer or any other digital communication device that includes a transceiver to communicate information via a cable interface.

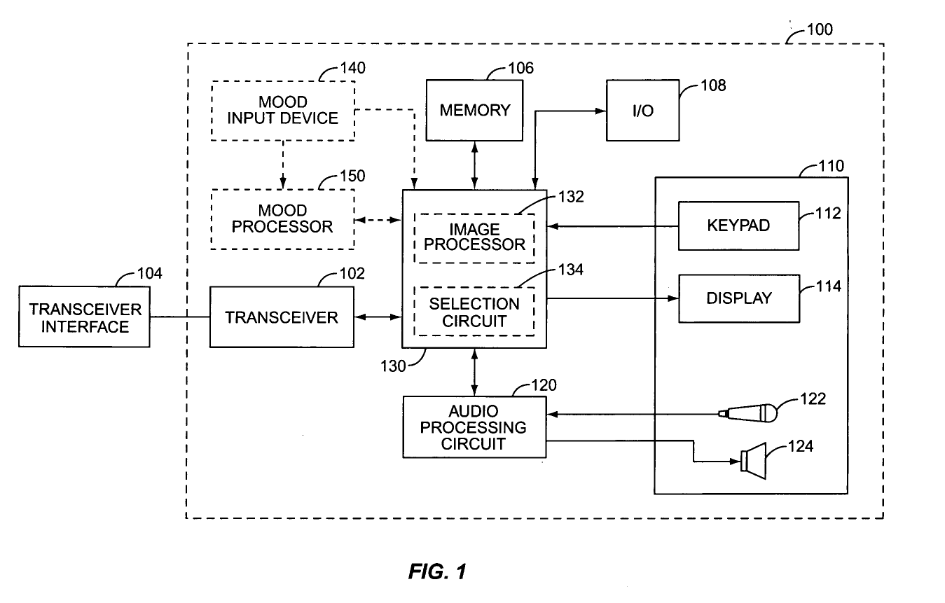

FIG. 1 illustrates a block diagram of an exemplary communication device 100 according to one or more embodiments of the present invention. Communication device 100 includes transceiver 102, transceiver interface 104, memory 106, optional input/output (I/O) device 108, user interface 110, audio processing circuit 120, system processor 130, and an optional mood input device 140 and/or mood processor 150. User interface 110 includes one or more user input devices 112 and an interface display 114 to enable the user to interact with and control communication device 100. The user input devices 112 may include a keypad, touchpad, joystick control dials, control buttons, other input devices, or a combination thereof. User input devices 112 allow the operator to enter numbers, characters, or commands, and scroll through menus and menu items presented to the user on interface display 114, and make selections. Display 114 allows the user to view information such as menus and menu items, dialed digits, images, call status information, and output from user applications.

User interface 110 may also include a microphone 122 and speaker 124. Microphone 122 receives audio input from the user, while speaker 124 projects audible sound to the user. In particular, microphone 122 converts the detected speech and other audible signals into electrical audio signals and speaker 124 converts analog audio signals into audible signals that can be heard by the user. Audio processing circuit 120 receives analog audio inputs from microphone 122 and provides the basic analog output signals to speaker 124. It will be appreciated that the audio processing circuit 120 in communication device 100 may include a voice recognition system (not shown) that receives and processes vocal instructions from the user.

System processor 130 performs various processing tasks, including controlling the overall operation of communication device 100 according to programs stored in memory 106. Memory 106 may include both random access memory (RAM) and read-only memory (ROM). Computer program instructions and data required for operation of communication device 100 are stored in non-volatile memory, such as EPROM, EEPROM, and/or flash memory, which may be implemented as discrete devices, stacked devices, or integrated with system processor 130.

The system processor 130 may be implemented in hardware, firmware, software, or a combination thereof, and may comprise a single microprocessor or multiple microprocessors. The microprocessors may be general-purpose microprocessors, digital signal processors, or other special purpose processors. Functions performed by system processor 130 may include signal processing and/or control of the overall operation of mobile device 100. In accordance with the present invention, and as discussed in greater detail below, system processor 130 may include an image processor 132 and/or selection circuit 134.

To communicate with other communication devices, communication device 100 includes at least one transceiver 102 coupled to transceiver interface 104. When transceiver 102 comprises a fully functional cellular radio transceiver, transceiver interface 104 comprises an antenna 104. In this scenario, transceiver 102 may operate according to any known standard, such as Global System for Mobile Communications (GSM), TIA/EIA-136, cdmaOne, cdma2000, UMTS, and Wideband CDMA. In addition, transceiver 102 may include baseband processing circuits to process signals transmitted and received by the transceiver 102. Alternatively, baseband processing circuits may be incorporated with system processor 130.

Further, transceiver 102 may also comprise a short-range wireless transceiver, such as a Bluetooth® transceiver 102 coupled to an antenna 104. As understood by those skilled in the art, Bluetooth® is a universal radio interface that enables two or more wireless devices to communicate wirelessly via short-range ad hoc networks. Jaap Haartsen in Ericsson Review No. 3, 1998, provides further details regarding Bluetooth® technology in “Bluetooth®—The universal radio interface for ad hoc, wireless connectivity.” While the present application may use the term “Bluetooth® transceiver” and “Bluetooth® network” to refer to a wireless interface for short-range communications, those skilled in the art will appreciate that the present invention is not limited to Bluetooth® systems and equipment, and that other short-range wireless interfaces, e.g., infra-red interfaces, are equally applicable.

The following describes the present invention in terms of the communication device 100 shown in FIG. 1. While the present invention is generally described in terms of a transceiver 102 connected to a wireless transceiver interface 104, it will be appreciated by those skilled in the art that transceiver interface 104 may connect to any known cable communication interface for communicating information with other communication devices.

The present invention provides an improvement in real-time communications, such as voice calls or instant messaging. In particular, the present invention provides a method for generating, transmitting, and displaying mood-specific images in association with real-time communications. According to the present invention, a personal image is selected or modified responsive to supplied mood data, and the resulting mood-specific image is output to an output device, such as display 114 or transceiver 102. For example, the mood-specific image may be transmitted to the far-end user for display at the far-end terminal, or may be displayed on an electronic display on the user's own terminal. The personal image may be any image, drawing, photograph, caricature, etc., representative of the particular individual associated with the mood data.

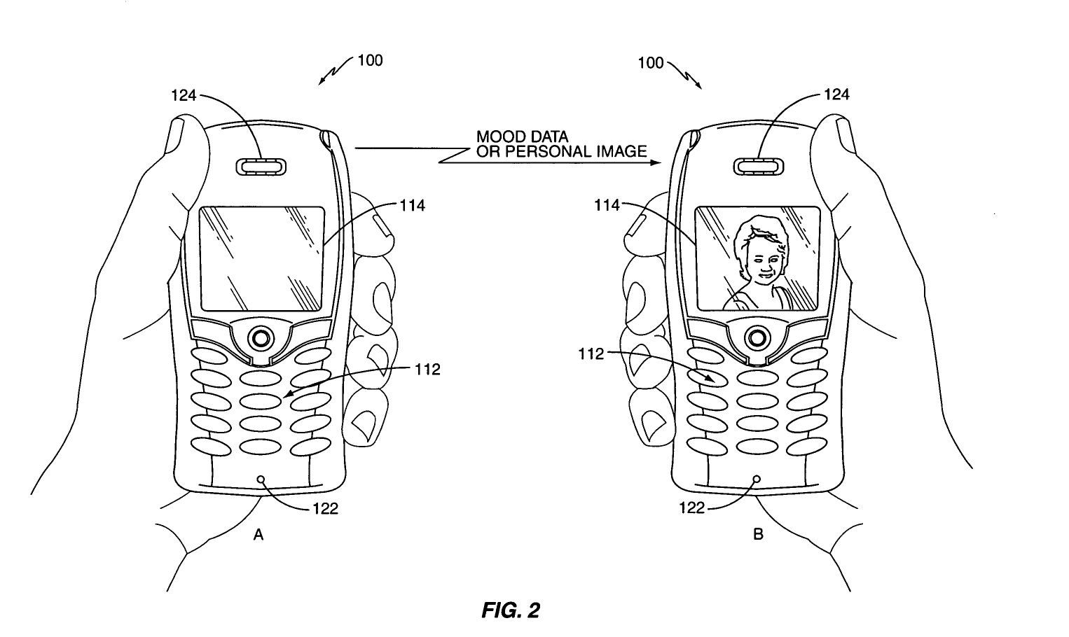

According to one exemplary embodiment of the present invention, a remote communication device 100 receives mood data from a near-end communication device 100 via transceiver 102 in association with a call, as shown in FIG. 2. Based on the received mood data, a personal image is selected or modified and output to display 114. The received mood data may comprise a specific mood indicator, such as happy, sad, angry, etc. Alternatively, the received mood data may comprise various mood characteristics, such as the near-end user's temperature, blood pressure etc., that may be processed in a mood processor 150 to determine the mood of the near-end user.

The near-end communication device 100 may transmit the mood data to the remote communication device 100 by any known means. For example, the mood data may be transmitted with other packet data associated with the call over a wireless or cable interface according to any known means. In a GPRS or EDGE wireless system, for example, the mood data may be transmitted as part of a call setup message along with the phone number of the near-end communication device 100. It will be appreciated that the present invention is not limited to any particular communication protocol, and therefore, may be implemented using any communication protocol that allows related data to be transmitted.

According to another exemplary embodiment, the near-end communication device 100 may select or modify a personal image of the near-end user responsive to mood data directly provided by the near-end user. The resulting personal image is output to transceiver 102, which transmits the mood-specific image to remote communication device 100 in association with a call, as shown in FIG. 2. It will be appreciated that the personal image may be transmitted to the remote communication device 100 using any communication protocol that allows the transmission of images along with voice or other communication data. For example, in a GPRS or EDGE system, a user profile stored in either the communication device 100 or in a network server may be modified to include an image field. By supplying the personal image to the image field of the user profile, the personal image may be transmitted to the remote communication device 100 during call setup. Further, during the call, new personal images may be transmitted as part of the packet data transmitted between the communication devices 100. As such, the personal image may change during the call to represent the changing moods of the near-end user.

As discussed further below, the personal image is selected or modified responsive to supplied mood data. According to the present invention, there are various ways to supply the mood data. For example, according to one embodiment of the present invention, the user may use keypad 112 to select the appropriate mood, i.e., happy, sad, angry, excited, stressed, worried, panicked, etc., from a menu of mood options. Similarly, when audio processing circuit 120 includes voice recognition capabilities, the user may provide the mood data by supplying an audio command to the communication device 100. For example, the user may state “happy” to select a happy mood, and therefore, to supply “happy” mood data to the communication device 100.

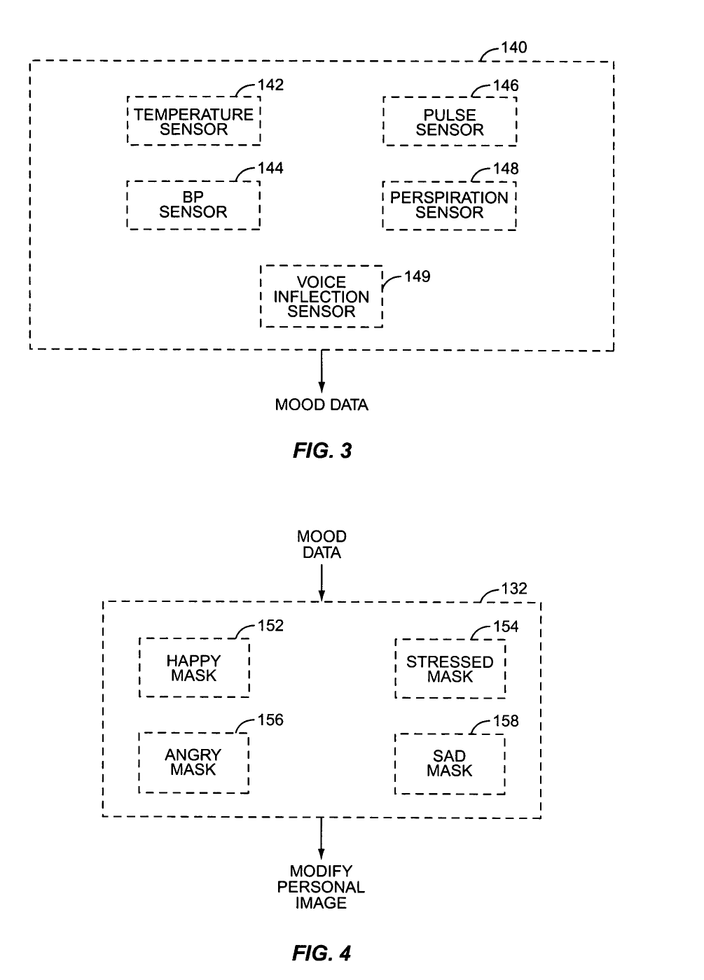

Alternatively, according to another embodiment of the present invention, communication device 100 may include a mood input device 140 that determines the user's mood based on one or more biological characteristics associated with the user. To that end, mood input device 140 may include one or more biofeedback sensors. As shown in FIG. 3, the biofeedback sensors may include, but are not limited to, a temperature sensor 142, a blood pressure sensor 144, a pulse sensor 146, a perspiration sensor 148, and/or a voice inflection sensor 149 that sense the temperature, blood pressure, pulse, perspiration, and/or voice inflection of the near-end user. Such sensors may be included as part of the housing of the communication device 100. Based on the sensed biological characteristics, mood processor 150 determines the mood data associated with the user according to any known means.

While mood input device 140 is shown as part of communication device 100, it will be appreciated that mood input device 140 may be external from and operatively connected to communication device 100 via a cable or a short-range wireless interface. Further, while mood processor 150 is shown as a separate device from system processor 130, those skilled in the art will appreciate that mood processor 150 may be incorporated with system processor 130.

Based on the supplied mood data, system processor 130 selects or modifies a personal image. According to one exemplary embodiment, an image processor 132 may retrieve a mood-neutral personal image of the user from memory 106, a network server (not shown), or any other electronic storage system accessible to the communication device 100. Image processor 132 then modifies the retrieved personal image according to any known means responsive to the supplied mood data to generate a mood-specific personal image. For example, as shown in FIG. 4, image processor 132 may include one or more masks that may include but are not limited to, a happy mask 152, a stressed mask 154, an angry mask 156, and/or a sad mask 158. While not shown, other masks may also be included, such as a concerned mask, pensive/thoughtful mask, surprised mask, frightened mask, etc. Based on the received mood data, image processor 132 selects the appropriate mask 152, 154, 156, 158 and applies the selected mask to the retrieved personal image to morph the expression of the mood-neutral personal image. The expression of the resulting mood-specific personal image corresponds to the received mood data. It will be appreciated that the resulting personal image may be a still image or an animated image.

According to another exemplary embodiment, system processor 130 may include a selection circuit 134. In this embodiment, memory 106 (or a network server) stores a set of personal images for each of one or more users. Each image in a given set of personal images provides an image of the associated user with a specific facial expression that corresponds to a specific mood. Therefore, based on the supplied mood data, selection circuit 134 may select a personal image from a set of personal images corresponding to the near-end user to generate the desired mood-specific personal image. As with the modified personal image, the selected personal image may be a still image or an animated image

The above describes exemplary communication devices 100 that may be used to implement the present invention. To further describe the present invention, FIGS. 5-7 illustrates exemplary methods 200 for implementing the present invention. As shown in FIG. 5, a communication device 100 initiates call setup (block 210) with another communication device 100. Based on supplied mood data (block 220), a personal image is selected or modified (block 230) and output to an output device (block 240). The output device may comprise a transmitter for transmitting the mood-specific image to a remote communication device 100, or a display at the local terminal.

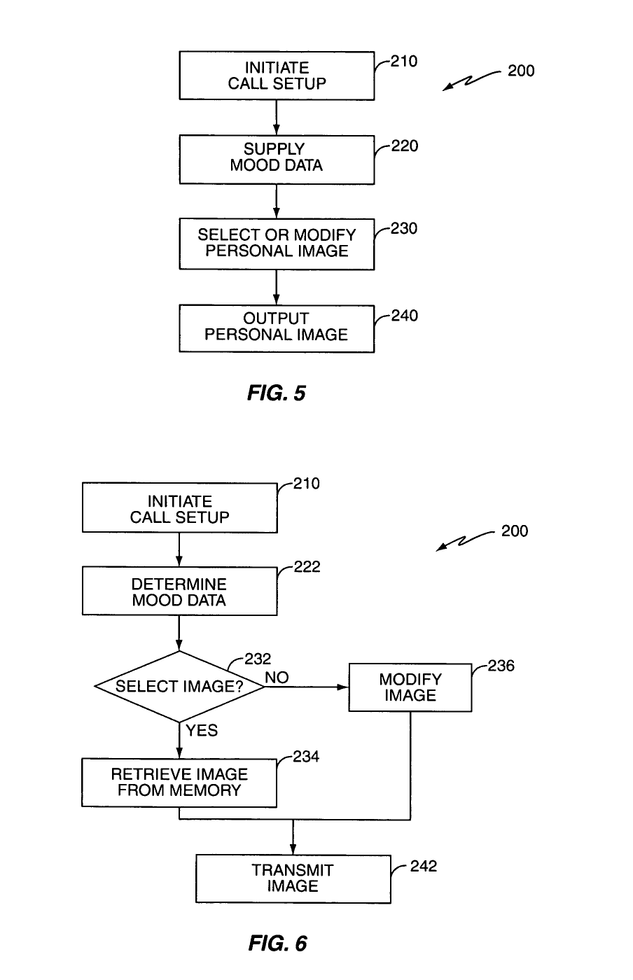

FIG. 6 illustrates one exemplary method 200 of the present invention. As shown in FIG. 6, communication device “A” (see FIG. 2) initiates call setup with communication device “B” (block 210). After the user's mood is determined (block 222), system processor 130 in communication device “A” either selects or modifies a personal image of the user of communication device “A” (block 232). If system processor 130 is configured to select a personal image (block 232), selection circuit 134 selects the personal image from memory 106 based on the sensed mood data (block 234). If system processor 130 is configured to modify a personal image (block 232), image processor 132 modifies the personal image based on the sensed mood data (block 236), as described above. The resulting personal image is then transmitted by transceiver 102 (block 242) to communication device “B”, where it is displayed on the display 114 of communication device “B”.

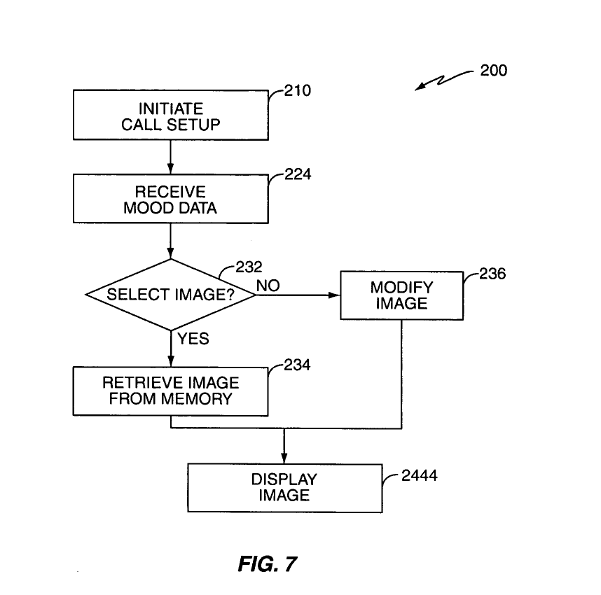

FIG. 7 illustrates another exemplary method 200. In this embodiment, when communication device “A” initiates call setup (block 210), communication device “B” receives mood data from communication device “A” (block 224). After receiving the mood data (block 224), the system processor 130 in communication device “B” either selects or modifies a personal image of the user of communication device “A” (block 232). If system processor 130 is configured to select a personal image (block 232), selection circuit 134 selects the personal image from memory 106 based on the received mood data (block 234). If system processor 130 is configured to modify a personal image (block 232), image processor 132 modifies the personal image based on the received mood data (block 236). The resulting personal image is then output to display 114 (block 244) of communication device “B”.

The above describes using memory 106 to store personal images and/or image masks. To provide the desired images and/or masks to memory 106, I/O port 108 may be used to connect to and download desired images and/or masks from external devices. I/O port 108 may comprise any type of known serial port, parallel port, or combination serial and parallel port. Exemplary I/O ports 108 include a Small Computer System Interface (SCSI) port, a Universal Serial Bus (USB) port, an Ethernet port, infra-red port, or any I/O port used to download information from an external device to system processor 130 and/or to memory 106. The downloaded information may include, but is not limited to, photographs, image masks, digital images, software, and the like. For example, a user and/or a network provider may download one or more masks from an internet web site via I/O port 108. Similarly, a user may download one or more images from a computer, digital camera, etc., via I/O port 108. It will be appreciated that the downloaded images may comprise mood-neutral or mood-specific images of one or more users. Further, it will be appreciated that the downloaded mood-specific images may be externally generated by any number of methods. For example, an external system may apply different masks to a mood-neutral personal image to generate a plurality of mood-specific personal images of an individual. Alternatively, a camera may be used to photograph multiple mood-specific images of the individual.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A method of providing an image in association with a call between two or more communication devices, the method comprising:
selecting or modifying a personal image of a user responsive to supplied mood data; and
outputting the personal image to an output device in association with the call.

2. The method of claim 1 wherein selecting or modifying the personal image comprises morphing the personal image responsive to the mood data.

3. The method of claim 2 wherein morphing the personal image comprises applying a mask to the personal image to change an expression associated with the personal image responsive to the mood data.

4. The method of claim 1 wherein selecting or modifying the personal image comprises selecting the personal image from memory based on the mood data.

5. The method of claim 1 further comprising sensing the mood data based on biological characteristics associated with the user.

6. The method of claim 5 wherein the biological characteristics comprises at least one of a temperature, blood pressure, pulse, perspiration, and voice inflection.

7. The method of claim 1 further comprising determining the mood data based on user input.

8. The method of claim 7 wherein the user input comprises at least one of a keypad entry and a voice command.

9. The method of claim 1 further comprising receiving the mood data from a remote communication device in association with the call.

10. The method of claim 9 wherein receiving the mood data comprises receiving a mood indicator from the remote communication device.

11. The method of claim 9 wherein receiving the mood data comprises receiving one or more biological characteristics associated with a user of the remote communication device.

12. The method of claim 1 wherein outputting the personal image comprises outputting the personal image to a transceiver to transmit the personal image to a remote communication device.

13. The method of claim 1 wherein outputting the personal image comprises outputting the personal image to a display.

14. The method of claim 1 wherein outputting the personal image comprises outputting one of an animated personal image and a still personal image.

15. The method of claim 1 wherein the supplied mood data comprises one of happy mood data, sad mood data, angry mood data, worried mood data, and stressed mood data.

16. The method of claim 1 wherein the personal image is output to the output device in association with initiating the call.

17. The method of claim 1 wherein the personal image is output to the output device during the call.

18. The method of claim 1 wherein selecting or modifying the personal image comprises selecting or modifying one or a photograph, a drawing, or a caricature of the user.

19. A communication device comprising:
a processor configured to select or modify a personal image responsive to mood data supplied to the communication device; and
an output device configured to output the personal image in association with a call.

20. The communication device of claim 19 further comprising a mood input device configured to supply the mood data, said mood input device operatively connected to the processor.

21. The communication device of claim 20 wherein the mood input device comprises one or more bio-feedback sensors to sense one or more biological characteristics associated with a user of the communication device.

22. The communication device of claim 21 further comprising a mood processor configured to determine the mood data based on the one or more sensed biological characteristics.

23. The communication device of claim 21 wherein the one or more bio-feedback sensors comprises at least one of a temperature sensor, a blood pressure sensor, a pulse sensor, a voice inflection sensor, and a perspiration sensor.

24. The communication device of claim 19 further comprising a keypad, wherein a user of the communication device supplies the mood data using the keypad.

25. The communication device of claim 19 further comprising:
a microphone; and
an audio processing circuit operatively connected to the microphone to supply the mood data responsive to voice commands received by the microphone.

26. The communication device of claim 19 wherein the processor comprises an image processor configured to modify the personal image responsive to the mood data.

27. The communication device of claim 26 wherein the image processor comprises a mask circuit configured to morph the personal image responsive to the mood data.

28. The communication device of claim 19 wherein the processor comprises a selection circuit configured to select the personal image from memory based on the mood data.

29. The communication device of claim 19 wherein the output device comprises a transceiver configured to transmit the personal image to a remote communication device in association with the call.

30. The communication device of claim 19 wherein the output device comprises a display to display the personal image in association with the call.

31. The communication device of claim 30 further comprising a transceiver to receive the mood data from a remote communication device.

32. The communication device of claim 19 wherein the output device outputs one of an animated personal image and a still personal image.

33. The communication device of claim 19 wherein the call comprises one of a communication session, a wireless call, a push-to-talk communication, and an instant messaging communication.

34. The communication device of claim 19 wherein the communication device comprises a mobile telephone.

35. The communication device of claim 19 wherein the personal image comprises one of a photograph, a drawing, or a caricature of the user.

36. A mobile station comprising:
a transceiver to receive mood data from a remote mobile station in association with a call;
a processor configured to select or modify a personal image of a user of the remote mobile station responsive to the received mood data; and
a display to display the personal image.

37. The mobile station of claim 36 wherein the processor comprises an image processor configured to morph the personal image responsive to the received mood data.

38. The mobile station of claim 36 further comprising a memory to store a plurality of personal images, wherein each of said personal images reflects a different mood of the user of the remote mobile station.

39. The mobile station of claim 38 wherein the processor comprises a selection circuit configured to select the personal image from the plurality of personal images stored in the memory based on the received mood data.

40. A method of providing an image in association with a call between two or more mobile stations, the method comprising:
selecting or modifying a personal image of a user responsive to supplied mood data; and
displaying the personal image on a display of at least one of the mobile stations in association with the call.

41. A mobile station comprising:
a processor configured to select or modify a personal image of a user of the mobile station responsive to mood data supplied by the user; and
a transceiver to transmit the personal image to a remote mobile station in association with a call.

42. The mobile station of claim 41 wherein the processor comprises an image processor configured to morph the personal image responsive to the supplied mood data.

43. The mobile station of claim 41 wherein the processor comprises a selection circuit configured to select the personal image from memory based on the supplied mood data.

44. A method of providing an image in association with a call between two or more mobile stations, the method comprising:
selecting or modifying a personal image of a user of a first mobile station responsive to supplied mood data; and
transmitting the personal image to one or more second mobile stations in association with the call.
